(19) United States
(12) Patent Application Publication
(10) Pub. No.: US 2015/0333793 A1
(43) Pub. Date: Nov. 19, 2015

(54) METHOD FOR REDUNDANTLY AND SECURELY TRANSFERRING DATA FROM A DATA SOURCE TO A DATA SINK

(71) Applicant: HIRSCHMANN AUTOMATION AND CONTROL GMBH, Neckartenzlingen (DE)

(72) Inventors: Markus RENTSCHLER, Dettingen (DE); Hans-Joachim FINKBEINER, Bempflingen (DE); Winit Kumar TIWARY, Stuttgart (DE)

(21) Appl. No.: 14/652,157

(22) PCT Filed: Dec. 20, 2013
(86) PCT No.: PCT/EP2013/077764

§ 371 Date: Jun. 15, 2015

(30) Foreign Application Priority Data
Dec. 21, 2012 (DE) 102012224229.5

(51) Int. Cl. H04B 1/74; H04L 1/22; H04B 7/06

(52) U.S. Cl. CPC H04B 1/74; H04B 7/0667; H04L 1/22

(57) ABSTRACT

Method for transferring data from a data source (1) to a data sink (2) and/or vice versa via at least two transmission links (5, 6) that operate independently of one another and wirelessly. A splitter (3) is supplied with the data from the data source (1) and the splitter (3) supplies the data to the at least two transmission links (5, 6). Also, the data transferred via the two transmission links (5, 6) are supplied to a combiner (4) and the combiner (4) forwards the received data to the data sink (2) on the basis of prescribed criteria. The invention is characterized in that the transfer of the data between the data source (1) and the data sink (2) and/or vice versa takes place with a different time response on the at least two wireless transmission links (5, 6) while the parallel redundancy protocol (PRP) is applied.

The invention relates to a method of transferring data from a data source to a data sink and/or vice versa via at least two transmission paths that operate independently of each other, the data of the data source being fed to a splitter that in turn feeds the data to the at least two transmission paths, where furthermore the data transferred via the two transmission paths are fed to a combiner that forwards the received data to the data sink in accordance with specified criteria according to the features of the preamble of claim 1.

The wireless communications diversity approach long known as prior art is the redundant transfer of data via stochastically independent channels that are highly unlikely to both be affected by errors at the same time.

In radio-transmission technology, a fundamental distinction is made between the following forms of diversity operating modes (known from: D. G. Brennan, “Linear diversity combining techniques,” Proc. IRE, vol. 47, no. 1, pp. 1075-1102, June 1959):

Time diversity—Payload data are sent multiple times via the same channel at different times in order to compensate for time-dependent fluctuations in the signal strength.

Spatial diversity—Two or more transmitting-receiving paths are operated. In the case of wireless transfer, this is done, for example by spatially separated antennas. The receiver selects the strongest received signal.

Frequency diversity—The same signal is simultaneously transferred via two or more carrier frequencies. In the event of interference or complete fading of the signal, it is to be expected that not all frequency ranges used are affected. For parallel transfer of the signal, two transmitters and receivers are operated in parallel using two frequency bands.

An important element in such a diverse transmission system is the so-called combiner recombines the redundant signals at the receiving end or selects the better signal for further processing. The combiner technologies are traditionally classified as follows in accordance with Brennan:

1) Scanning combiner

2) Selection combiner

3) Maximum-ratio combiner

4) Equal-gain combiner

In general, however, only discrete signal states at a certain time on the redundant channels are examined, for example at the bit level or byte level in the case of digital transmission. However, in the case of packet-oriented data transfer, a long bit sequence or byte sequence is transferred over a certain time period as a signal, which bit sequence or byte sequence can be defined as a signal unit to be examined. For example, this signal unit can be an Ethernet packet or an 802.11 packet with regard to the contents of the signal unit.

For this special case, the so-called timing combiner can be defined as follows as a derivative of the selection combiner:

In the transmission of such long signal units (for example Ethernet packets), the arrival time of a copy of the complete and integral signal unit can occur at clearly different times on the receiver side in the case of parallel transmission channels experiencing different interference, for example because of repeated transmissions on a single one of the radio channels. In this case, the timing combiner, as a derivative of the selection combiner, makes the forwarding decision when the first complete and integral copy of the signal unit is received. The essential advantage of this method lies in a statistical improvement of the time behavior with regard to the latency variability (jitter), because the signal unit (for example, Ethernet packet) arriving earlier always “wins.”

In patent WO 2006/053459 “Reception of redundant and non-redundant frames” of ABB Switzerland Ltd, Corporate Research, Segelhofstr 1K, CH-5405 Baden, a mechanism is described that provides seamless redundancy in that the data traffic between terminals is transferred in duplicate via two parallel redundant wired networks. The object of this invention is high availability in the event of the failure of one of the parallel networks, which high availability can occur by this method without any impairment to the data traffic.

This method was standardized in IEC 62439-3 as the Parallel Redundancy Protocol (PRP). In connection therewith, a so-called redundancy box (RedBox) is also described that also contains, in addition to the three wired network interfaces (network adapter) as per IEEE 802.3, the so-called link redundancy entity (LRE), i.e. the bidirectional splitter and combiner function of PRP (bridging logic).

In IEC 62439-3, this method is limited to the use with Ethernet: “The IEC 62439 series is applicable to high-availability automation networks based on the ISO/IEC 8802-3 (IEEE 802.3) (Ethernet) technology.”

A network comprising a controller and a sensor/actuator and having two redundant transmission paths is known from DE 10 2009 053 868.

The object of the invention is to improve data transfer with regard to performance behavior, in particular with respect to the reliability of the transferred data.

This problem is solved by the features of claim 1.

According to the invention, the data are transferred between the data source and the data sink and/or vice versa with different time behavior on the at least two wireless transmission paths, and the Parallel Redundancy Protocol (PRP) is applied. The wireless transfer of the data between the data source and the data sink has the advantage that the devices in which the data sink and the data source are located can be stationary, especially without a cable connection therebetween. The transfer via exactly two transmission paths or more than two transmission paths increases the transmission reliability. If one of the two or more transmission paths experiences interference or fails completely, another transmission path via which the data can be transferred is always available. Thus, there is redundancy for reliability reasons. Because the Parallel Redundancy Protocol is applied in the transfer of the data, there is the advantage that . . . [sic]

Furthermore, the transfer of data with different time behavior is especially advantageous because it exploits the fact that it is highly probable that no simultaneous transmission interference occurs in the case of diverse parallel redundant wireless connections and therefore in contrast to singular wireless transmission channels the probability of packet loss is minimized by such a transmission system in such a way that the wireless transfer can be regarded as reliable.

In a development of the invention, only the data that have been transferred without errors via one of the transmission paths are forwarded by the combiner to the data sink. This means that the combiner is designed and suitable for first receiving the data transferred via the at least two transmission paths. In accordance with specified criteria, the combiner decides that only the data that have been transferred without errors via one of the transmission paths are forwarded to the data sink. A decision criterion can be that the combiner detects that the data that have been transferred via the one transmission path are error-free while the data that have been transferred via the other transmission path have errors. For example, for the data that are transferred in data packets, this can be a check bit. If the combiner determines that the data that have been transferred via the transmission paths are all error-free, the transmission path by means of which the data transferred without errors first arrived at the combiner can be selected on the basis of the transfer with different time behavior, for example. In addition, it is conceivable that the combiner already forwards to the data sink those data that have been completely transferred via a transmission path, even if it turns out that the data likewise transferred without errors and arriving at the combiner later also could have been forwarded to the data sink.

In an alternative embodiment of the invention, the data that have been transferred totally without errors via the at least two of the transmission paths are forwarded to the data sink by the combiner. As a decision criterion here, the combiner uses the fact that the combiner checks the data, for example the data packets, that have been transferred via the at least two transmission paths for freedom from errors or faults and combines those data, in particular data packets, into a total data stream (into a total data packet) that is supposed to be transferred without errors via the transmission paths and originates from the data source, and then composes the total data packet after the error-free packet-oriented transfer and forwards the total data packet to the data sink. Thus, a total data packet that originates from the data source is divided by the splitter, and individual data packets are wirelessly transferred in the direction of the combiner with different time behavior via the two transmission paths. Then, the data packets that have been transferred without errors are combined in the combiner into the total data packet to be transferred and are forwarded to the data sink. Of course, it is possible that the total data packet is wirelessly transferred and arrives at the combiner without errors both on the one transmission path and on the other transmission path. However, because the transfer occurs with different time behavior, for example with a time offset, one total data packet arrives at the combiner earlier and therefore is forwarded to the data sink. The other total data packet that likewise arrives at the combiner without errors (or with errors) is then discarded by the combiner. However, a particular advantage is that the total data packet is divided into individual sub-packets that either are transferred via the one transmission path and the other transmission path with different time behavior or are divided among the two transmission paths and transferred there with different time behavior. Here also, however, it is especially advantageous if the total packet is transferred via the at least two wireless transmission paths with different time behavior and then those data packets of the total packets that have been transferred without errors via one or the at least two transmission paths are recombined into the total data packet by the combiner. Thus, the advantage is effectively achieved that, in the case of interference of one or both or several transmission paths from a perspective of reliability, the total data packet originally transmitted by the data source can nevertheless arrive at the combiner completely and without errors and then is forwarded to the data sink.

Therefore, according to the invention, the term “timing combiner” means a type of selection combiner that handles signal units consisting of long byte sequences, such as data packets, that are transferred via parallel redundant transmission paths with significantly different time behavior, such as wireless radio transmission paths.

According to a novel feature of the invention, a wireless variant of a redundancy box (RedBox) has, instead of Ethernet interfaces, a wireless communication interface for each of the two parallel redundant networks. These wireless interfaces can be done by WLAN as per IEEE 802.11, for example, but other radio standards also can be used.

This invention should make it possible, for example, to technically implement the method of reliable wireless data transfer described in DE 10 2009 053 868. The characteristic is used that it is highly probable that no simultaneous transmission interference occurs in the case of diverse parallel redundant wireless connections and therefore in contrast to singular wireless transmission channels the probability of packet loss is minimized by such a transmission system in such a way that the wireless transmission can be regarded as reliable.

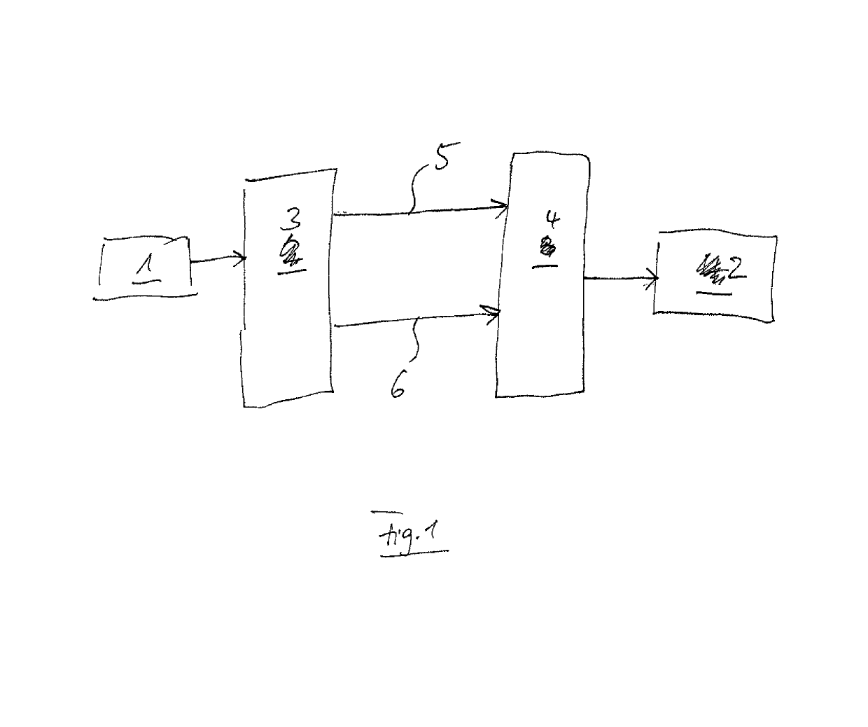

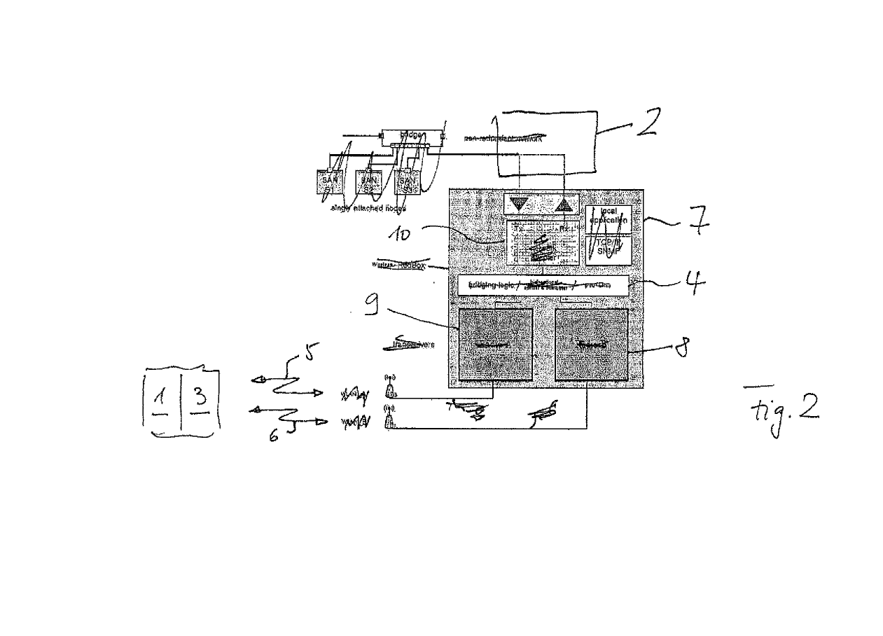

An embodiment example for performing the method according to the invention is shown in FIGS. 1 and 2 and is explained in more detail below.

In FIG. 1, to the extent shown in detail, an arrangement is shown that comprises a data source 1 and a data sink 2. Data arise in the data source 1 or are transmitted by this data source 1. For example, the data source 1 can be a server on the Internet from which a user wants to receive data, and in this case the user or the user's computer is the data sink 2. However, the data source 1 can also be a sensor whose data should be sent to a control unit. The data source 1 can just as well be a control unit that sends data to the data sink 2 in dependence on captured and calculated parameters, and in such a case the data sink 2 is an actuator. The data source 1 can also be a computer from which data are sent to the data sink 2 that is a printer. The afore-mentioned examples are used only for explanation and should not be considered restrictive.

The data are sent by the data source 1 to a splitter 3. The splitter 3 is responsible for and is designed for sending the data to a combiner 4 on the side of the data sink 2. The splitter 3 and the combiner 4 are generally set at a large spacing from each other. To bridge this spacing, at least two transmission paths 5 and 6 that operate independently of each other are provided, and these transmission paths 5 and 6 are wired. The combiner 4 is responsible for and is designed for receiving the data divided by the splitter 3 and fed to the two transmission paths 5 and 6 and forwarding this data to the data sink 2 in accordance with specified criteria.

The embodiment according to FIG. 1 shows the unidirectional data transfer from the data source 1 to the data sink 2. Alternatively to this unidirectional data transfer, it is also conceivable that bidirectional data transfer occurs. In this case, the data source 1 would be not only a pure data source but also a data sink. The same applies to the data sink 2 that in the case of bidirectional data transfer would also be a data source. Also, the splitter 3 according to FIG. 1 would also have a combiner function and the combiner 4 according to FIG. 1 would also have a splitter function in the case of bidirectional data transfer. Also, the transmission paths 5 and 6 would be suitable and designed for data to be transferred in both directions via the transmission paths 5 and 6.

The case of bidirectional data transfer is shown in FIG. 2. The transmission paths 5 and 6 connected to an unillustrated splitter/combiner and a corresponding data source and data sink transfer data to a connecting unit 7 and can also but not necessarily go from the connecting unit 7 via the transmission paths 5 and 6. Within the connecting unit 7, a respective receiver 8 or 9 is present for each transmission path 5 and 6, and these receivers 8 and 9 are also transmitters having corresponding transmitter characteristics in the case of bidirectional data transfer. On the basis of the specified criteria, the combiner 4 determines which of the data fed to it by the receivers 8 and 9 are fed to a network adapter 10. The data transferred via the transmission paths 5 and 6 and received and processed by the connecting unit 7 are then forwarded to the connected data sink 2 by this network adapter 10.

In the case of bidirectional data transfer, a data source is also connected to the connecting unit 7, for which reason the network adapter 10 is designed to process these data outputted to the network adapter 10 by the data source and to forward this data to the combiner 4 shown in FIG. 2. In this case, the combiner 4 shown in FIG. 2 not only is a combiner but also has splitter functions. The same then applies, as already stated, to the receivers 8 and 9 that then are not only receivers but also transmitters in order to output data onto the transmission paths 5 and 6.

### List of Reference Signs

1 data source

2 data sink

3 splitter

4 combiner

5 transmission path

6 transmission path

7 connecting unit

8 receiver

9 receiver

10 network adapter

1. A method of transferring data between a data source and a data sink, the method comprising the steps of:
feeding data of from the data source to a splitter;
feeding the data in two streams from the splitter via to at least two respective wireless transmission paths operating independently of each other to a combiner;
forwarding with the combiner the received data to the data sink in accordance with specified criteria; and
imparting to the data being transferred between the data source and the data sink different time behaviors on the at least two wireless transmission paths, according to a Parallel Redundancy Protocol.

2. The method according to claim 1, wherein the data are transferred in signal units that consist of byte sequences that are transferred with different time behavior via the transmission paths.

3. The method according to claim 1, wherein only the data that have been transferred without errors via one of the transmission paths are forwarded to the data sink by the combiner.

4. The method according to claim 1, wherein the data that have been transferred in the totality thereof without errors via the at least two transmission paths are forwarded to the data sink by the combiner.
